(19) United States
(12) Patent Application Publication
(10) Pub. No.: US 2005/0140494 A1
(43) Pub. Date: Jun. 30, 2005

(54) Customer management system using IC cards

(75) Inventor: Keiji Takakura, Tokyo (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/022,524

(22) Filed: Dec. 23, 2004

(30) Foreign Application Priority Data
Dec. 25, 2003 (JP) 2003-431432

(51) Int. Cl. G06F 7/00; G08C 19/00; G08B 29/00; G05B 19/00

(52) U.S. Cl. 340/5.6; 705/41

(57) ABSTRACT

A customer management system is composed of: an IC card, terminals respectively provided for branch offices, and a management server including a customer management database. The IC card includes a region for storing favorite office information indicating a favorite branch office(s). The terminals are each designed to program the IC card using a reader/writer to register a desired favorite branch office as one of the favorite branch office(s) within the favorite office information, and to transmit registration information representative of the desired favorite branch office to the management server. The management server is programmed to update the customer management database in response to the registration information so that the customer management database contains an association of a customer owning the IC card and the favorite branch office(s) indicated by the favorite office information.

### BACKGROUND OF THE INVENTION

1. Field of the Invention

The present invention relates to customer management systems using IC cards for achieving improved customer information management.

2. Description of the Related Art

Monitoring customers' preference is one of the most difficult but important issues for product dealer companies, who desire to achieve improved customer satisfaction. This is especially difficult for a company running a lot of stores or branch offices; although the company's attention is often paid to provision of uniform services in all of the stores, the number of customers is usually different for each store.

One approach for gaining better understanding of customers is to have frequent contact with customers. This is often achieved by issuing member cards to customers. Member cards are typically designed to store customer information, such as store visiting frequency. This allows the company to provide special services for frequent customers, and to thereby achieve customer satisfaction. Such member cards are useful to better understand customers.

Member cards storing customer information are also useful for achieving efficient customer management, as disclosed in Japanese Open Laid Patent Application No. P2001-22838A. Such member cards are usually comprised of an IC card incorporating an IC chip.

A dealer company often desires to understand customers' store choice with respect to the stores owned by the dealer. When multiple stores owned by the same dealer company are available, customers naturally select one that provides relatively high quality services. However, it is not easy for the dealer company to capture such customers' preference, because reputation on the service quality is usually exchanged only among customers. It would be advantageous if a system is provided which allows a product dealer company to gain a real-time understanding of the reputation with customers concerning the individual stores that the product dealer company owns.

### SUMMARY OF THE INVENTION

Therefore, one object of the present invention is to provide a system that allows a dealer company running multiple stores to easily understand the reputation of the individual stores from the customers' viewpoint.

Another object of the present invention is to provide a system that allows a dealer company to gain better understand the reason(s) why a certain customer stops visiting a certain store.

Still another object of the present invention is to provide a system that allows a dealer to appropriately deal with customers who stop visiting a certain store, and to thereby avoid customer satisfaction being unachieved.

In an aspect of the present invention, a customer management system is composed of: an IC card; a plurality of terminals respectively provided for branch offices; a plurality of reader/writers respectively connected to the plurality of terminals; and a management server including a customer management database, the management server being communicatable with the plurality of terminals through a network. The IC card includes a region for storing favorite office information indicating at least one favorite branch office. The plurality of terminals are each designed to program the IC card using associated one of the plurality of reader/writers to register a desired favorite branch office selected out of the plurality of branch offices as one of the favorite branch office(s) within the favorite office information, and to transmit registration information representative of the desired favorite branch office to the management server in response to completion of programming the IC card. The management server is programmed to update the customer management database in response to the registration information so that the customer management database contains an association of a customer owning the IC card and the favorite branch office(s) indicated by the favorite office information.

It is preferable that the plurality of terminals are programmed to provide a prompt to input a registration reason for the desired favorite branch office, and to transmit the registration reason to the management server, and the management server is programmed to update the customer management database in response to the registration reason received from relevant one of the plurality of terminals.

When the reader/writes are each designed to obtain the favorite office information from the IC card, and to output the obtained favorite office information to associated one of the plurality of terminals, the plurality of terminals are preferably programmed to be responsive to an unregistration request indicative of one of the at least one favorite branch office to be unregistered for unregistering the indicated favorite branch office from the favorite office information within the IC card.

When the plurality of terminals are programmed to the unregistration request to generate an office unregistration message indicating the unregistered favorite branch office, and to transmit the office unregistration message to the management server through the network, the customer management server is preferably programmed to inform one of the plurality of terminals associated with the unregistered favorite branch office, that the unregistered favorite branch office is unregistered from the favorite office information.

It is also preferable that the plurality of terminals are programmed to provide a prompt to input an unregistration reason for the unregistered one of the at least one favorite branch office, and to transmit the registration reason to the management server, and the management server is responsive to the office unregistration message to inform the one of the plurality of terminals associated with the unregistered one of the at least one favorite branch office that the unregistered one of the at least one favorite branch office is unregistered from the favorite office information.

In this case, the management server is preferably responsive to the unregistration reason for transmitting address change information to the one of the plurality of terminals associated with the unregistered favorite branch office, when the unregistration reason is related to a change of an address of the customer owning the IC card

When the plurality of terminals respectively include customer databases storing customer data, the management server is preferably programmed to issue a request for outputting customer data associated with the registration information received through the network in response to the registration information, and to update the customer management database based on the customer data outputted in response to sad request.

It is also preferable that the plurality of terminals are programmed to indicate the IC card to update the favorite office information, and to assert a flag disposed within the customer management database when updating the favorite office information is unsuccessfully completed.

### BRIEF DESCRIPTION OF THE DRAWINGS

FIG. 1 is a block diagram showing an exemplary structure of a customer management system in one embodiment of the present invention;

FIG. 2 is a block diagram showing a configuration of an IC card in this embodiment;

FIG. 3 is a customer management table stored in a customer management database;

FIG. 4 is a store management table stored in a store database;

FIG. 5 is a registration reason table stored in a registration reason database;

FIG. 6 is an unregistration reason table stored in an unregistration reason database;

FIG. 7 is a customer table stored in a customer database;

FIG. 8 is a flowchart showing an exemplary register process of “favorite” stores in this embodiment;

FIG. 9 is a flowchart showing an exemplary unregister process of “favorite” stores in this embodiment; and

FIG. 10 is a flowchart showing an exemplary operation of database update in this embodiment.

### DESCRIPTION OF THE PREFERRED EMBODIMENTS

In one embodiment, the present invention is applied to a customer management system for a vehicle company, which uses member cards for customer management. It should be understood that the present invention is not limited to a customer management system for a vehicle company, and applicable to a customer management system for any kind of entities issuing member cards to customers or clients.

### System Structure

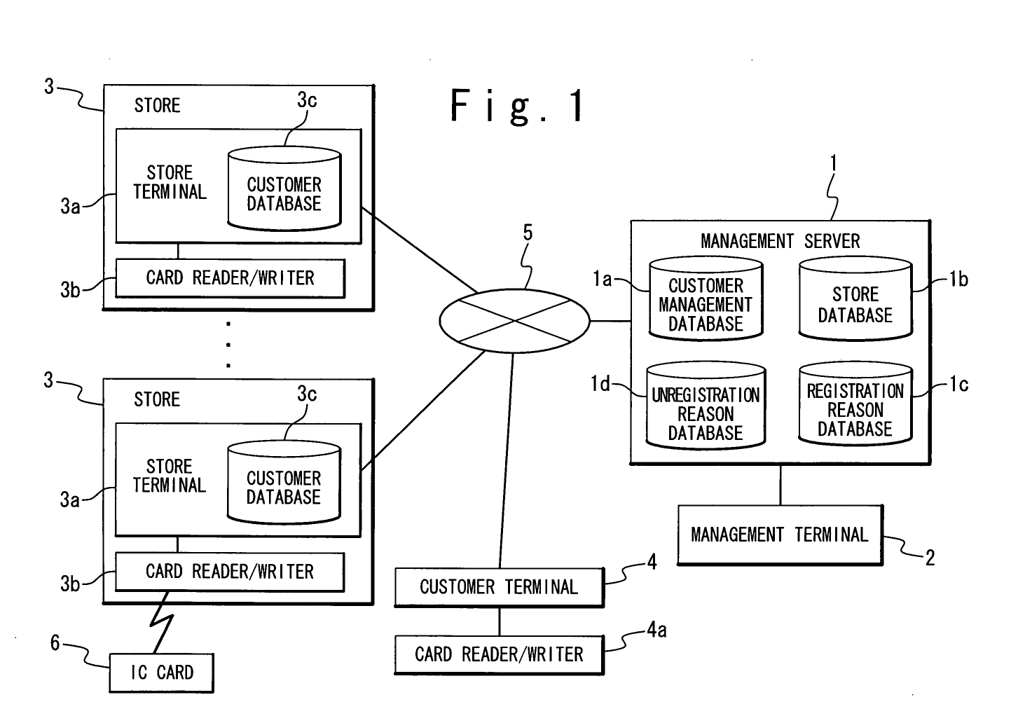

FIG. 1 is a block diagram of the customer management system in this embodiment. The customer management system is provided with a management server 1, a management terminal 2, store terminals 3a, card reader/writers 3b, customer terminals 4 (one shown), and a network 5. The management server 1 contains four databases in a storage unit: a customer management database 1a, a store database 1b, a registration reason database 1c, and an unregistration reason database 1d. The management terminal 2 is connected to the management server 1, and used for managing the databases provided within the management server 1. The store terminals 3a and the card reader/writers 3b are provided for respective stores 3 at which the vehicle company sells products. The store terminals 3a each include a customer database 3c. The customer terminal 4 is provided for operation of a customer. The customer terminal 4 is designed to be connectable to a card reader/writer 4a.

The four databases within the management server 1 contain necessary information for overall customer management of the respective stores 3. The customer management database 1a contains overall customer information, including information on “favorite” stores of customers. As described later, the customer management system is designed to allow customers to register their “favorite” stores, selected out of the stores 3, into the customer management database 1a in accordance with the customers' choice. The contents of the customer management database 1a are linked with those of the customer databases 3c within the store terminals 3a. The store database 1b contains information on the stores 3. The registration reason database 1c stores therein information on the reasons why the customers register specific stores as the “favorite” stores. The unregistration reason database 1d stores therein information on the reasons why the customers selects specific stores to be excluded from their “favorite” stores.

The management server 1 may be composed of a general-purpose computer including a storage device, an information processor, and an interface unit. In this case, the storage device is used for storing the customer management database 1a, the store database 1b, the registration reason database 1c, and the unregistration reason database 1d. The information processor is configured to perform various processing procedures, including updating the databases, in response to data received through the network 5. The information processor is also configured to operate in response to indications received from the management terminal 2. The interface unit is used to provide communications for the management server 1.

The management terminal 2 is provided for operation of the used as a man-machine interface of the customer management system. The management terminal 2 may include various input devices, such as a keyboard, a microphone, and a touch panel disposed on the display screen.

The store terminals 3a are provided for operation of the staff of the stores 3. The store terminal 3a are connectable to the management server 1 through the network 5. As is the case of the management terminal 2, the store terminal 3a is used as a man-machine interface of the customer management system. The store terminal 3a may include various input devices, such as a keyboard, a microphone, and a touch panel disposed on the display screen.

The store terminals 3a are connected card reader/writers 3b for accessing IC cards 6 (one shown), which are used as member cards issued by the vehicle company. The reader/writers 3b are designed to obtain data from the IC cards 6 and to forward the obtained data to the management server 1. Additionally, the reader/writers 3b are designed to program the IC cards 6 with data received from the management server 1 and the store terminals 3a.

The store terminals 3a are also designed to store customer information in the customer database 3c.

The customer terminals 4 are other man-machine interfaces provided for operation of the customers. General-purpose information processor devices owned by the customers, such as personal computers and PDAs (personal data assistants) may be used as the customer terminals 4. The customer terminals 4 may include various input devices, such as a keyboard, a microphone, and a touch panel disposed on the display screen.

The network 5 provides communications among the management server 1, the store terminals 3a, and the customer terminals 4. A wide area network, such as the Internet may be used as the network 5.

### IC Card Configuration

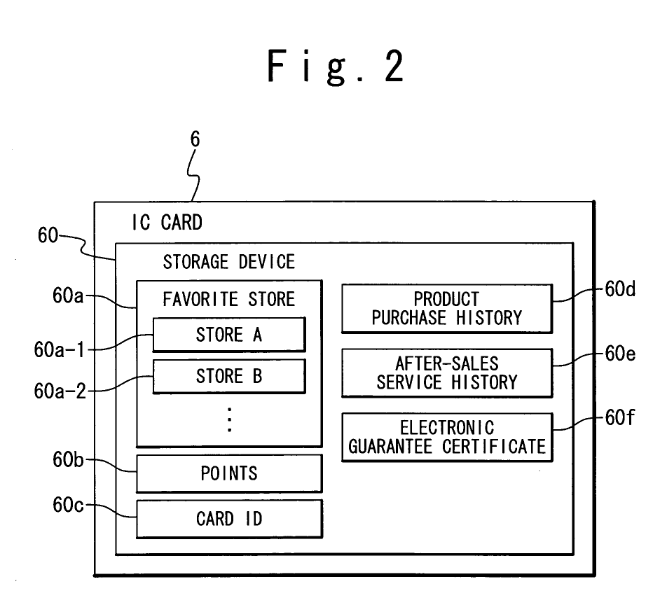

FIG. 2 illustrates an exemplary configuration of the IC cards 6. The IC cards 6 each include a non-volatile storage device 60 for storing information on the customer owning the IC card 6. The information stored in the storage device 60 includes favorite store data 60a, point data 60b, a card ID 60c, product purchase history data 60d, after-sales service history data 60e, and an electronic guarantee certificate 60f.

The favorite store data 60a is representative of the “favorite” store(s), which is selected by the customer who own the IC card 6. The storage device 60 incorporates a region in which the favorite store data 60a is contained, and the region is allowed to be accessed only in response to operation of the customer. It should be noted that the customer may select a plurality of stores as his/her “favorite” stores. FIG. 2 indicates the case when Stores A and B, denoted by numerals 60a-1 and 60a-2, are selected as the “favorite” stores.

The number of the favorite stores may be limited to be equal to or less than a predetermined maximum value; the IC card 6 may be designed not to allow the storage device 60 to store the “favorite” stores more than the maximum value. Configuring the IC card 6 with the maximum allowable number of the “favorite” stores allows each store to provide appropriate services in response to the customer's choice with respect to the “favorite” stores. For example, a certain store may provide a sales campaign in which the certain store provides a special service for a customer who selects the certain store as his/her “favorite” store.

The point data 60b represents the amount of the purchase points that the stores 3 donate to the customer. When a customer purchases a vehicle or orders a charged maintenance/inspection service, the customer is given purchase points for the expense thereof. The stores 3 provide cash back or a free additional service for the purchase points.

The card ID 60c is used to identify the IC cards 6. The IC cards 6, which are the member cards issued by the vehicle company, are each given a unique ID. The IC cards 6 each store the ID as the card ID 60c.

The product purchase history data 60d represents the purchase history of the customer. When purchasing a vehicle for the first time, a customer is given an IC card 6. When the customer who already has the IC card 6 purchases another vehicle, the product purchase history data 60d is updated to include information on the newly purchased vehicle, including the purchase date.

The after-sales service history data 60e represents the history of maintenance/inspection services provided for the vehicle purchased by the customer. When the vehicle experiences a periodic inspection or an accidental maintenance/inspection or repair, the after-sales service history data 60e is updated to include the log of the periodic inspection, the maintenance/inspection, or the repair.

The electronic guarantee certificate 60f is information equivalently valid as the guarantee certificate in paper form. The electronic guarantee certificate 60f is used to certificate the guarantee when a vehicle of a customer who has the guarantee certificate in paper form at home experiences failure at a distant place.

### Database Contents

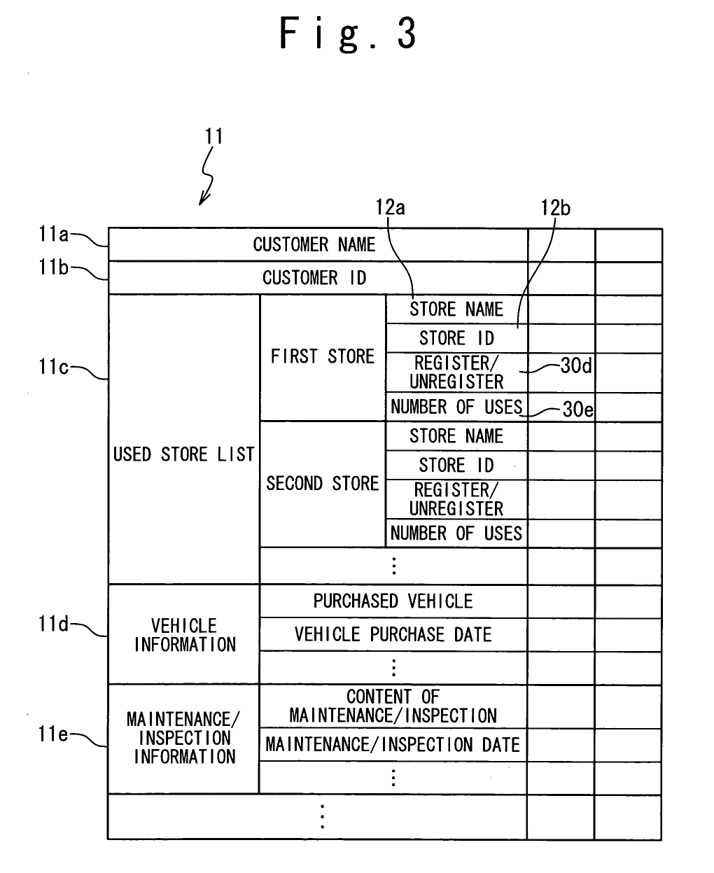

FIG. 3 illustrates contents of a customer management table 11 stored in the customer management database 1a. The customer management database 1a contains customer name data 11a, customer IDs 11b, purchasing store data 11c, vehicle information 11d, and maintenance/inspection information 11e, which are correlated with one another.

The customer name data 11a are representative of the names of the customers. The customer IDs 11b are used to identify the customers.

The used store data 11c are composed of information on the stores used by each customer. If a certain customer uses a plurality of stores, the used store data 11c include information on all of the used stores. Specifically, the used store data 11c are composed of store name data 12a, store IDs 12b, register/unregister flags 30d, and number-of-use data 30e. The store name data 12a represent the names of the stores 3 used by each customer. The store IDs 12b are used to identify the stores used by each customer. The register/unregister flags 30d represent whether each store is registered as the “favorite” store or not by the associated customer. When a certain customer registers a certain store as his/her “favorite” store, the associated register/unregister flag 30d is asserted. Correspondingly, when the certain customer unregisters the store as his/her “favorite” store, the associated register/unregister flag 30d is negated. When a certain register/unregister flag 30d is asserted to represent that the associated store is selected as the “favorite” store, the asserted register/unregister flag 30d is associated with a registration reason within the registration reason database 1c; this allows extracting the registration reason associated with the asserted register/unregister flag 30d from the registration reason database 1c.

The vehicle information 11d is information on the vehicles owned by the customers.

The maintenance/inspection information 11e is information on the maintenance/inspection services provided for the vehicles owned by the customers.

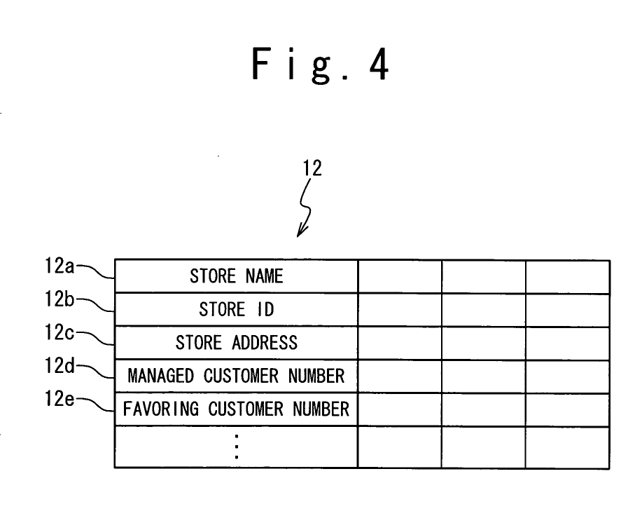

FIG. 4 illustrates contents of a store management table 12 stored in the store database 1b. The store database 1b contains store name data 12a, store IDs 12b, store address data 12c, managed customer number data 12d, and favoring customer number data 12e, which are correlated with one another. The store name data 12a represent the names of the stores 3. The store IDs 12b are used to identify the stores used by each customer. The store address data 12c describes the addresses of the stores 3. The managed customer number data 12 represent the number of customers managed by each store 3. The favoring customer number data 12e represent the numbers of the customers who have the IC cards 6 indicating that the customers register the respective stores as their “favorite” stores.

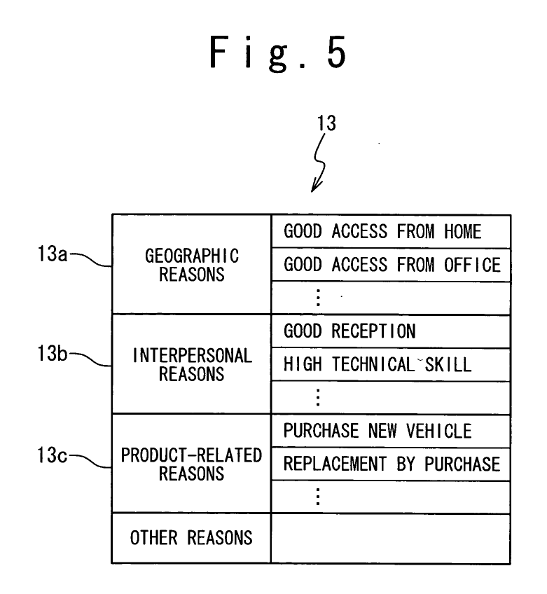

FIG. 5 is a registration reason table 13 provided within the registration reason database 1c. The registration reason database 1c contains reasons why the customers select the respective stores as their favorite stores, including geographical reasons 13a, interpersonal reasons 13b, and product-related reasons 13c. The reasons described in the registration reason database 1c are correlated with the asserted register/unregister flags 30d.

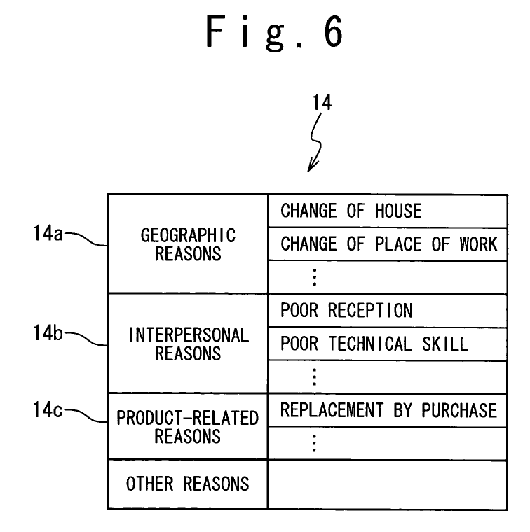

FIG. 6 is an unregistration reason table 14 provided within the unregistration reason database 1d. The registration reason database 1c contains reasons why the customers select the respective stores to be excluded from their “favorite” stores, including geographical reasons 13a, interpersonal reasons 13b, and product-related reasons 13c. When specific stores are selected to be excluded from the “favorite” stores, the associated register/unregister flag 30d is negated, and the reason is described in the unregistration reason database 1d to be correlated with the negated register/unregister flag 30d.

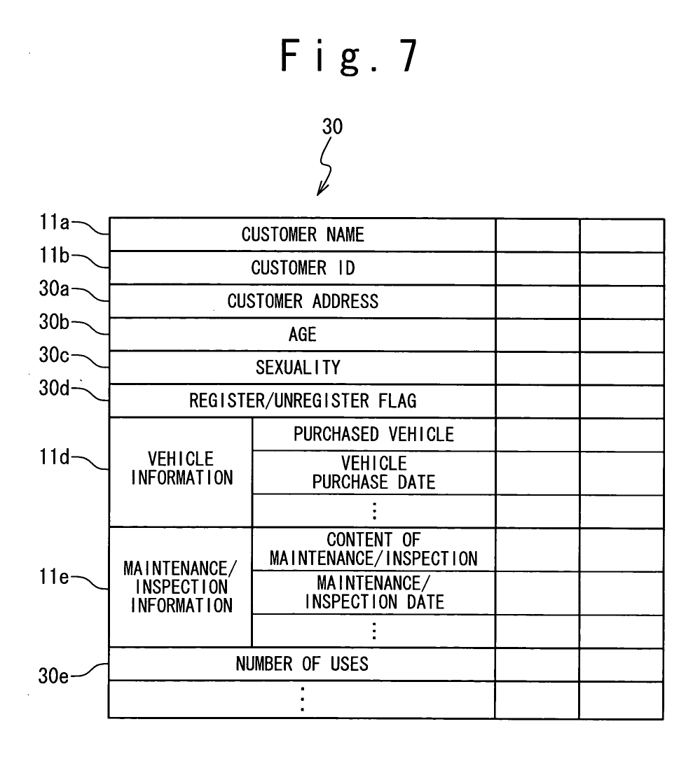

FIG. 7 illustrates contents of a customer table 30 provided within the customer databases 3c of the respective store terminals 3a. The customer databases 3c each include customer name data 11a, customer IDs 11b, customer address data 30a, customer age data 30b, customer sexuality data 30c, register/unregister flags 30d, vehicle information 11d, maintenance/inspection information 11e, and number-of-use data 30e.

The contents of each data and information within the customer databases 3c are as set forth above. It should be noted that the register/unregister flags 30d, which indicates that the respective customers select specific stores as their “favorite” stores, are also stored in the customer databases 3c in addition to the customer management database 1a within the management server 1.

### System Operation

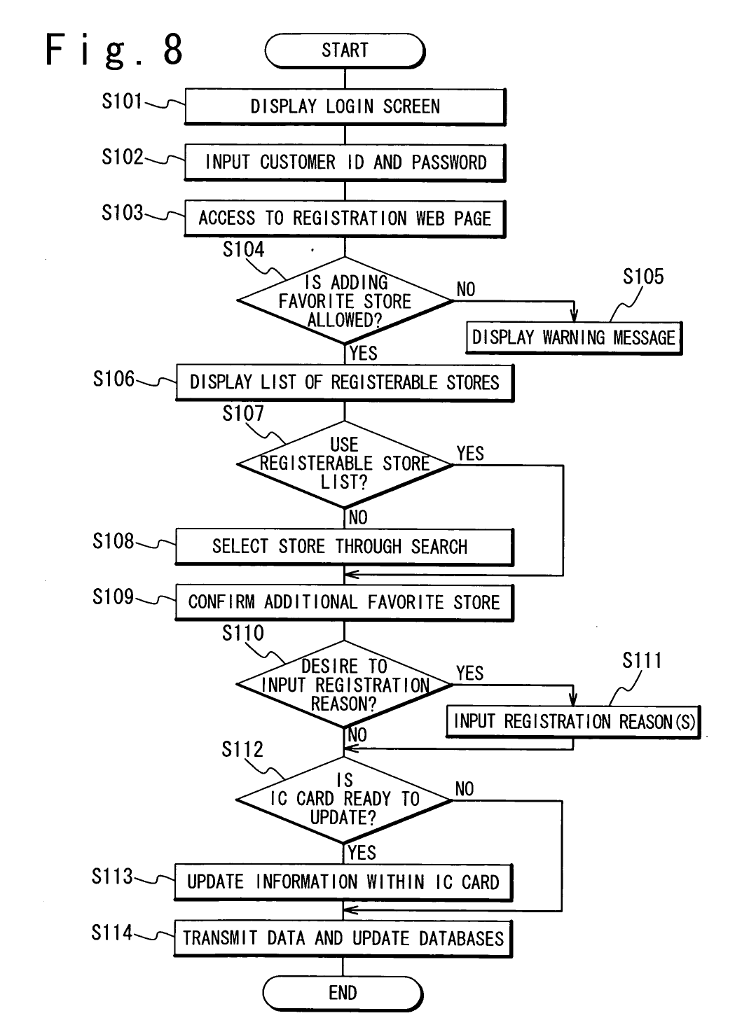

FIG. 8 is a flowchart showing the operation of the customer management system in which a customer registers a specific store as his/her “favorite” store. The registration of the customer's “favorite” store may be achieved by using the store terminals 3a, or the customer terminal 4. In this embodiment, the operation is described with an assumption that selected one of the store terminals 3a is used for the registration, which is provided in the store 3 where the customer visits. It should be noted that the customer terminal 4 may be used for the registration of the “favorite” store in place of the store terminals 3a.

The register process of the “favorite” stores begins with executing a predetermined operation on the store terminal 3a. The predetermined operation may be initiated by allowing the store terminal 3a to read information stored in the IC card 6 of the customer. In an alternative embodiment, the store terminal 3a may be configured to automatically display a login screen for a “favorite” store registration web page in response to the connection of the IC card 6 with the card reader/writer 3b. It should be noted that the registration operation may begin with accessing a login Web page used for the registration of the “favorite” store from a customer terminal 4a when the customer terminal 4a is not connected to a card reader/writer 4a.

At Step S101, the customer terminal 3a displays a login screen through executing a login screen generating program in response to establishment of a connection between the IC card 6 and the card reader/writer 3b. The connection between the IC card 6 and the card reader/writer 3b may be achieved through a wired or wireless link; the connection may be achieved through inserting the IC card 6 into a slot disposed in the card reader/writer 3b, or through approaching the IC card 6 to the card reader/writer 3b to establish a wireless communication link therebetween.

At Step S102, the customer is prompt to input a customer ID and a password. The customer ID and the password are forwarded to the management server 1 through the network 5. The management server 1 authenticates the customer using data stored in an authentication database (not shown).

At Step S103, the store terminal 3a accesses the registration web page in response to the authentication being successfully completed. In an alternative embodiment, the customer management system may include a dedicated Web server providing the registration page, and the store terminal 3a may access the dedicated Web server to obtain the registration page.

At Step S104, the store terminal 3a determines whether or not the store selected by the customer is allowed to be additionally registered as the favorite store. The number of the “favorite” stores that have been already registered is compared with the allowable maximum number of the “favorite” stores for the customer. When the number of the registered “favorite” stores already reaches the allowable maximum number, the procedure jumps to Step S105, and the store terminal 3a generates an error message on the display screen thereof, which informs that the number of the registered “favorite” stores has already reached the allowable maximum number. If not so, the store terminal 3a accesses the store database 1b to extract a list of stores that are not registered as the “favorite” stores at Step S106.

The customer may use the list generated at Step S106 to select his/her “favorite” store in accordance with his/her choice. When the customer uses the list to select his/her “favorite” store, the procedure jumps to Step S109. The customer is also allowed to select his/her “favorite” store without using the list. In this case, the customer is prompt to select a search button disposed on the screen to access a store search page at Step S108. Typing in a search keyword allows selecting a desired store as the “favorite” store.

At Step S109, the management server 1 issues an inquiry on the registration web page for prompting the customer to confirm the “favorite” store to be registered. Responding to the inquiry allows the customer to confirm the “favorite” store to be selected.

At Step S110, the management server 1 issues another inquiry on the registration web page for prompting the customer to input the reason why the customer selects the registered store as his/her “favorite” store. When the customer desires to input the reason, the procedure goes to Step S111. At Step S111, the management server 1 accesses the registration reason database 1c, and generates a list of items of the reasons for selecting the “favorite” stores. The customer is allowed to input the reason for selecting the “favorite” store by selecting one or more items out of the listed items. After the reason is inputted, the procedure proceeds to Step S112. The customer is also allowed to manually input the reason by using the keyboard. When the customer manually input the reason, the store terminal 3a forwards the inputted reason to the management server 1, and the management server 1 updates the registration reason database 1c to include the inputted reason. This effectively allows the vehicle company to better understand factors on which the customers' store choice depends.

When the customer does not desire to input the reason at Step 111, the procedure directly jumps to Step S112.

At Step S112, the store terminal 3a judges whether the IC card 6 is ready to update information stored therein. The judgment depends on whether or not the IC card 6 is connected to the card reader/writer 3b (or the card reader/writer 4a). If the IC card 6 is connected to the card reader/writer 3b (or the card reader/writer 4a), the information stored in the storage device 60 of the IC card 6 is updated to include the newly registered “favorite” store.

When the IC card 6 is not ready at Step S112, the store terminal 3a generates a message including an unsuccessful update flag that indicates the information stored in the IC card 6 is not updated yet.

At the step S114, the store terminal 3a transmits the information about the additionally registered “favorite” store through the network 5 to the management server 1; the transmitted information is composed of the message including the unsuccessful update flag if the information stored in the IC card 6 is not updated yet. The management server 1 updates the information stored in the customer management database 1a in accordance with the received information. When the management server 1 finds the unsuccessful update flag in the received information, the management server 1 stores the unsuccessful update flag so as to be associated with the additionally registered “favorite” store. When the IC card 6 gets ready through being connected to the IC card 6 to a card reader/writer 3b or 4a, the information stored in the IC card 6 is updated in response to the unsuccessful update flag. After the updating is completed, the unsuccessful update flag is negated.

The customer management system may be designed to add or modify the registration reasons stored in the management server 1. In one embodiment, the registration web page may be configured to add or modify the registration reasons, and the management server 1 may add or modify the registration reasons in response to requests received from the store terminals 3a, the customer terminal 4, or the management terminal 2. This is achieved through performing a process identical to Steps S112 to S114.

The aforementioned operation allows the customer to register his/her “favorite” stores in both the IC card 6 and the customer management database 1a. The registration of the “favorite” stores allows the respective stores 3 to provide special services for the favoring customers. The registration of the “favorite” stores is also effective for the staff of the vehicle company; the staff of the vehicle company achieves better understanding of the customers' preference through analyzing the information stored in the customer management database 1a, including the reasons why specific stores are selected as the “favorite” stores. In other words, the staff of the vehicle company can understand the reputation with the customers about the stores 3; one typical reputation is that a certain store is often registered as the “favorite” store after customers newly buy vehicles. Another typical reputation is that another store is registered as the “favorite” store due to the popularity of the reception staff.

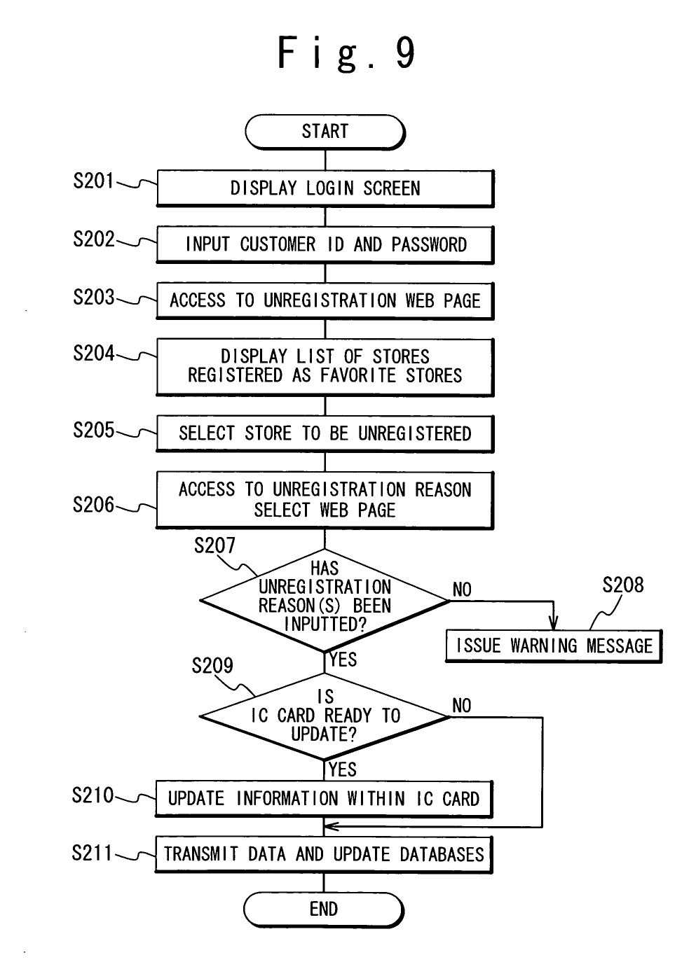

FIG. 9 is a flowchart illustrating an exemplary unregister process of the “favorite” stores. The unregister process of the customer's “favorite” store may be achieved by using the store terminals 3a, or the customer terminal 4. In this embodiment, the operation is described with an assumption that selected one of the store terminals 3a is used for the unregistration, which is provided in the store 3 where the customer visits. It should be noted that the customer terminal 4 may be used for the unregistration of the “favorite” store in place of the store terminals 3a.

The unregister process of the “favorite” stores begins with by executing a predetermined operation on the store terminal 3a; the predetermined operation may be initiated by allowing the store terminal 3a to read information stored in the IC card 6 of the customer. In an alternative embodiment, the store terminal 3a may be configured to automatically display a login screen for a “favorite” store unregistration web page in response to the connection of the IC card 6 with the card reader/writer 3b. It should be noted that the unregistration process may begin with accessing a login Web page used for the unregistration of the “favorite” store from a customer terminal 4a when the customer terminal 4a is not connected to a card reader/writer 4a.

At Step S201, the customer terminal 3a displays a login screen through executing a login screen generating program in response to establishment of a connection between the IC card 6 and the card reader/writer 3b. The connection between the IC card 6 and the card reader/writer 3b may be achieved through a wired or wireless link; the connection may be achieved through inserting the IC card 6 into a slot disposed in the card reader/writer 3b, or through approaching the IC card 6 to the card reader/writer 3b to establish a wireless communication link therebetween.

At Step S202, the customer is prompt to input a customer ID and a password in the login screen. The customer ID and the password are forwarded to the management server 1 through the network 5. The management server 1 authenticates the customer using the data stored in the authentication database (not shown).

At Step S203, the store terminal 3a accesses the unregistration web page in response to the authentication being successfully completed. In an alternative embodiment, the customer management system may include a dedicated Web server providing the unregistration page, and the store terminal 3a may access the dedicated Web server to obtain the unregistration page.

At Step S204, the store terminal 3a reads the favorite store data 60a from the IC card 6 through the card reader/writer 3b, and displays the “favorite” stores listed in the favorite store data 60a on the display screen. At Step S205, the customer is prompt to select one or more “favorite” stores to be unregistered from the favorite store data 60a using the displayed list.

After indicating the “favorite” stores to be unregistered, at Step 206, the management server 1 issues an inquiry on the unregistration web page, prompting the customer to input an unregistration reason(s). At Step S207, the management server 1 tries to confirm that the unregistration reason(s) is inputted, and issues a warning message on the display screen of the store terminal 3a when the unregistration reason(s) is not inputted at Step S208. When the unregistration reason(s) is inputted, the procedure jumps to Step S209.

At Step S209, the store terminal 3a judges whether the IC card 6 is ready to update information stored therein. The judgment depends on whether or not the IC card 6 is connected to the card reader/writer 3b (or the card reader/writer 4a). If the IC card 6 is connected to the card reader/writer 3b (or the card reader/writer 4a), the information stored in the storage device 60 of the IC card 6 is updated at Step S210 to unregister the “favorite” store(s) selected by the customer from the favorite store data 60a within the storage device 60.

When the IC card 6 is not ready at Step S209, the store terminal 3a generates a message including an unsuccessful update flag that indicates the information stored in the IC card 6 is not updated yet.

At the step S211, the store terminal 3a transmits to the management server 1 the information about the “favorite” store to be unregistered from the management server 1 through the network 5; the transmitted information is composed of the message including the unsuccessful update flag if the information stored in the IC card 6 is not updated yet. The management server 1 updates the information stored in the customer management database 1a in accordance with the received information. When the management server 1 finds the unsuccessful update flag in the received information, the management server 1 stores the unsuccessful update flag so as to be associated with the additionally registered “favorite” store. When the IC card 6 gets ready through being connected to the IC card 6 to a card reader/writer 3b or 4a, the information stored in the IC card 6 is updated in response to the unsuccessful update flag. After the updating is completed, the unsuccessful update flag is negated.

The customer management system may be designed to add or modify the unregistration reasons stored in the management server 1. In one embodiment, the unregistration web page may be configured to add or modify the unregistration reasons, and the management server 1 may add or modify the unregistration reasons in response to requests received from the store terminals 3a, the customer terminal 4, or the management terminal 2. This is achieved through performing a process identical to Steps S209 to S211.

In a preferred embodiment, the management server 1 is designed to generate a data table indicative the registration and unregistration reasons for each store. The management server 1 is programmed to generate an evaluation sheet for each store, including the degree of the customer satisfaction. This allows a sales manager of the vehicle company to provide directions for each store 3 on the basis of the evaluation sheet, and to reduce service differences among the stores 3.

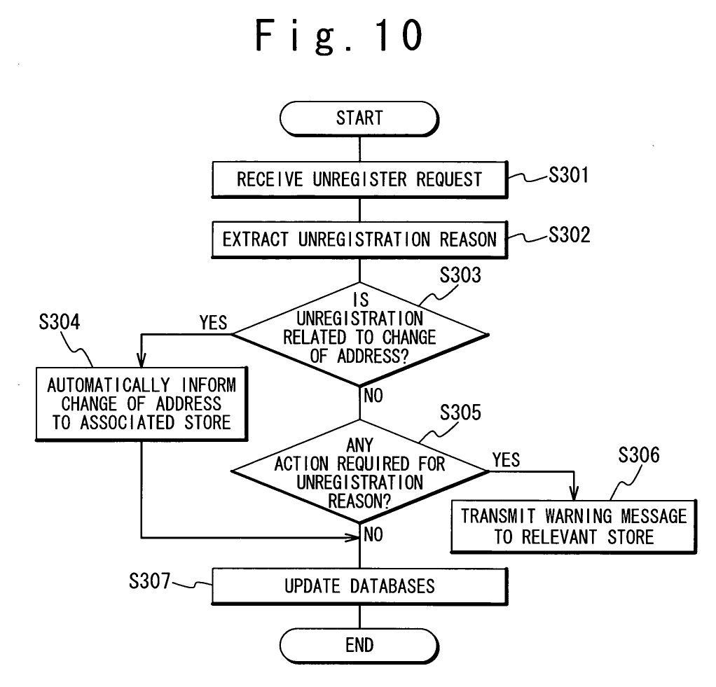

FIG. 10 is a flowchart illustrating an exemplary process of updating the databases provided within the management server 1. Although the process illustrated in FIG. 10 addresses unregistration of the “favorite” store(s), this does not mean that the databases within the management server 1 are updated only when the unregistration of the “favorite” store(s) is requested; the registration of additional “favorite” stores is performed in the same manner as the unregistration.

At Step S301, the management server 1 receives an unregistration request from the associated store terminal 3a (or the customer terminal 4). At Step S302, the management server 1 extracts the unregistration reason(s) indicated in the unregistration request. At Step S303, the management server 1 analyzes the unregistration reason(s) to determine whether the unregistration reason(s) is related to a change of the customer's address.

When the unregistration reason(s) is related to a change of the customer's address, such as a change of the house or a change of the place of work, the procedure proceeds to Step S304. At Step S304, the management server 1 transmits address change information informing the change of the customer's address to the store terminal 3a provided for the store experiencing the unregistration from the “favorite” stores. Upon receiving the address change information, the relevant store terminal 3a updates the customer database 3c in accordance with the address change information.

When the unregistration reason(s) is not related to the change of the customer's address, the procedure proceeds to the Step S304.

At Step S305, the management server 1 determines whether the unregistration reason(s) is directed to one that requires any action for customers, such as unregistration resulting from lack of skills. If so, the management server 1 transmits a warning message to the store terminal 3a of the relevant store on the basis of the unregistration reason(s) at Step S306.

In the case when the address change information is transmitted at Step S304, or when the management server 1 determines that no action is required, the process proceeds to Step S307. At Step S307, the management server 1 updates the relevant databases stored therein.

Although the invention has been described in its preferred form with a certain degree of particularity, it is understood that the present disclosure of the preferred form has been changed in the details of construction and the combination and arrangement of parts may be resorted to without departing from the scope of the invention as hereinafter claimed.

1. A customer management system comprising:
an IC card;
a plurality of terminals respectively provided for branch offices;
a plurality of reader/writers respectively connected to said plurality of terminals; and
a management server including a customer management database, said management server being communicable with said plurality of terminals through a network,
wherein said IC card includes a region for storing favorite office information indicating at least one favorite branch office,
wherein said plurality of terminals are designed to write information indicative of a desired favorite branch office selected out of said plurality of branch offices onto said IC card using associated ones of said plurality of reader/writers to thereby register said desired favorite branch office as one of said at least one favorite branch office within said favorite office information, and to transmit registration information representative of said desired favorite branch office to said management server in response to completion of writing onto said IC card, and
wherein said management server is programmed to update said customer management database in response to said registration information so that said customer management database contains an association of a customer owning said IC card with said at least one favorite branch office indicated by said favorite office information.

2. The customer management system according to claim 1, wherein said plurality of terminals are programmed to provide a prompt to input a registration reason for said desired favorite branch office, and to transmit said registration reason to said management server, and
wherein said management server is programmed to update said customer management database in response to said registration reason received from relevant one(s) of said plurality of terminals.

3. The customer management system according to claim 1, wherein said reader/writers are designed to obtain said favorite office information from said IC card, and to output said obtained favorite office information to associated ones of said plurality of terminals, and
wherein said plurality of terminals are programmed to be responsive to an unregistration request indicative of one of said at least one favorite branch office to be unregistered for unregistering said one of said at least one favorite branch office from said favorite office information within said IC card.

4. The customer management system according to claim 3, wherein said plurality of terminals are programmed to be responsive to said unregistratioin request for generating an office unregistration message indicating said unregistered one of said at least one favorite branch office, and for transmitting said office unregistration message to said management server through said network, and
wherein said customer management server is programmed to inform one of said plurality of terminals associated with said unregistered one of said at least one favorite branch office, that said unregistered one of said at least one favorite branch office is unregistered from said favorite office information.

5. The customer management system according to claim 4, wherein said plurality of terminals are programmed to provide a prompt to input an unregistration reason for said unregistered one of said at least one favorite branch office, and to transmit said unregistration reason to said management server, and
wherein said management server is responsive to said office unregistration message to inform said one of said plurality of terminals associated with said unregistered one of said at least one favorite branch office that said unregistered one of said at least one favorite branch office is unregistered from said favorite office information.

6. The customer management system according to claim 5, wherein, when said unregistration reason is related to a change of an address of said customer owning said IC card, said management server is responsive to said unregistration reason for transmitting address change information to said one of said plurality of terminals associated with said unregistered one of said at least one favorite branch office.

7. The customer management system according to claim 1, wherein said plurality of terminals respectively include customer databases storing customer data, and
wherein said management server is programmed to issue a request for outputting customer data associated with said registration information received through said network in response to said registration information, and to update said customer management database based on said customer data outputted in response to said request.

8. The customer management system according to claim 1, wherein said plurality of terminals are programmed to indicate said IC card to update said favorite office information, and to assert a flag disposed within said customer management database when updating said favorite office information is unsuccessfully completed

9. A method of operating a customer management system including an IC card, a plurality of terminals respectively provided for branch offices, a plurality of reader/writers respectively connected to said plurality of terminals, and a management server including a customer management database, said management server being communicable with said plurality of terminals through a network, and said IC card comprising a region for storing favorite office information indicating at least one favorite branch office, said method comprising the steps of:
writing information indicative of a desired favorite branch office selected out of said plurality of branch offices onto said IC card by one of said plurality of terminals using an associated one of said plurality of reader/writers to thereby register said desired favorite branch office as one of said at least one favorite branch office within said favorite office information;
transmitting registration information representative of said desired favorite branch office to said management server in response to completion of writing onto said IC card, and
updating said customer management database by said management server in response to said registration information so that customer management database contains an association of a customer owning said IC card with said at least on favorite branch office indicated by said favorite office information.

10. The method according to claim 9, further comprising the steps of:
providing a prompt on said one of said plurality of terminals to input a registration reason for said desired favorite branch office,
transmitting said registration reason to said management server; and
updating said customer management database in response to said registration reason received from relevant one of said plurality of terminals.

11. The method according to claim 9, further comprising the steps of:
obtaining said favorite office information from said IC card: and
issuing an unregistration request indicative of one of said at least one favorite branch office to be unregistered; and
unregistering one of said at least one favorite branch office from said favorite office information within said IC card in response to said unregistration request.

12. The method according to claim 11, further comprising the steps of:
generating an office unregistration message indicating said unregistered one of said at least one favorite branch office in response to said unregistration request;
transmitting said office unregistration message to said management server through said network; and
informing one of said plurality of terminals associated with said unregistered one of said at least one favorite branch office, that said unregistered one of said at least one favorite branch office is unregistered from said favorite office information.

13. The method according to claim 12, further comprising the steps of:
providing a prompt to input an unregistration reason for said unregistered one of said at least one favorite branch office, and to transmit said unregistration reason to said management server, and
in response to said office unregistration message, informing said one of said plurality of terminals associated with said unregistered one of said at least one favorite branch office that said unregistered one of said at least one favorite branch office is unregistered from said favorite office information.

14. The customer management system according to claim 13, further comprising the step of:
in response to said unregistration reason, transmitting address change information to said one of said plurality of terminals associated with said unregistered one of said at least one favorite branch office, when said unregistration reason is related to a change of address of said customer owning said IC card.

15. The method according to claim 9, wherein said plurality of terminals respectively include customer database storing customer data, and said method further comprising the steps of:
issuing a request for outputting customer data associated with said registration information received through said network in response to said registration information; and
updating said customer management database based on said customer data outputted in response to said request.

16. The method according to claim 9, further comprising the steps of:
indicating said IC card to update said favorite office information; and
asserting a flag disposed within said customer management database when updating said favorite office information is unsuccessfully completed.
